(19) United States
(12) Patent Application Publication
(10) Pub. No.: US 2008/0213626 A1
(43) Pub. Date: Sep. 4, 2008

(54) METHOD OF MANUFACTURE OF GLASS SUBSTRATE FOR INFORMATION RECORDING MEDIUM, METHOD OF MANUFACTURE OF MAGNETIC RECORDING DISK, AND MAGNETIC RECORDING DISK

(75) Inventors: Ryoji KOBAYASHI, Matsumoto City (JP); Youichi TEI, Matsumoto City (JP); Kouichi TSUDA, Matsumoto City (JP)

Correspondence Address: ROSSI, KIMMS & McDOWELL LLP., P.O. BOX 826, ASHBURN, VA, 20146-0826, US

(73) Assignee: FUJI ELECTRIC DEVICE TECHNOLOGY CO., LTD., Tokyo (JP)

(21) Appl. No.: 11/971,373

(22) Filed: Jan. 9, 2008

(30) Foreign Application Priority Data
Jan. 9, 2007 (JP) 2007-001241

(51) Int. Cl. G11B 5/33; B44C 1/22

(52) U.S. Cl. 428/800; 216/22

(57) ABSTRACT

A method of manufacture of a glass substrate for a magnetic recording medium, which has both high substrate strength and low alkaline elution, includes an etching process of etching the inner-edge face of a donut-shaped glass substrate having an aluminosilicate composition, formed by removing the center portion of a die-molded disc-shaped glass substrate, and an alkali sealing process of performing alkali sealing treatment by proton substitution of alkali ions in the surface layer of the etched donut-shaped glass substrate. The process is used to manufacture a magnetic recording medium incorporating a glass substrate having a total alkaline elution amount of less than 3.1 μg/disk, wherein the magnetic recording medium has a transverse rupture strength greater than 132 N.

### BACKGROUND

The invention relates to a method of manufacture of a glass substrate for an information recording medium, a method of manufacture of a magnetic recording disk, and to a magnetic recording disk manufactured by the method of manufacture of a magnetic recording disk.

In the past, aluminum substrates and glass substrates have been used as the substrates in magnetic recording disks for hard disk devices and in other information recording media. Glass disks have come into wide use in recent years due to their high hardness and smoothness. Glass substrates with higher hardness have been in demand for use in magnetic recording disks. Glass substrates which have been strengthened through chemical tempering are widely employed.

As glass used in chemically tempered glass substrates, aluminosilicate glass is suitable. It is known that glass containing 62 to 75 weight percent SiO₂, 5 to 15 weight percent Al₂O₃, 4 to 10 weight percent Li₂O, 4 to 12 weight percent Na₂O, and 5.5 to 15 weight percent ZrO₂, and in which the Na₂O/ZrO₂ weight ratio is 0.5 to 2.0 and the Al₂O₃/ZrO₂ weight ratio is 0.4 to 2.5, is still more suitable (see for example Japanese Patent Laid-open No. 8-335315).

In chemical tempering, K ions are substituted for the Li ions and Na ions in the vicinity (within approximately 10 μm) of the glass surface, to form compressive stress at the surface and temper the glass. For this reason, the glass must be brought into contact for a long period of time at high temperatures with a salt comprising the ions to be substituted into the glass. The method most commonly used involves immersing the glass in the molten salt containing the ions. The temperature at which ion substitution is performed is 500 to 600° C. or below. Nitrates, which have melting points lower than this temperature range and do not significantly erode the glass surface, are suitable as ion substitution salts. KNO₃ (melting point 339° C.) is generally used as the substitution salt. In the case of glass comprising Li, NaNO₃ (melting point 308° C.), or a salt mixture containing this salt, are used. The molten salt temperature and the immersion duration depend on the glass composition and on the strength to be obtained, but normally a temperature of 380 to 450° C. and a duration of from several hours to ten or so hours are used.

Use of glass substrates not subjected to chemical tempering in magnetic recording disks is also being studied. For example, glass substrate has been proposed which employs glass comprising 52 to 65 weight percent SiO₂, 10 to 18 weight percent Al₂O₃, 0 to 8 weight percent B₂O₃, 0 to 10 weight percent MgO, 2 to 15 weight percent CaO, 0 to 15 weight percent SrO, 0 to 16 weight percent BaO, and 0 to 12 weight percent ZnO, which does not effectively comprise alkali metal oxides, and the surface of the inner-diameter edge face of which has been etched to 5 μm or more (see for example Japanese Patent Laid-open No. 9-12333).

The glass substrate described in Japanese Patent Laid-open No. 9-12333 is fabricated by cutting plate glass manufactured by the float method. Although the float method is suited to mass production, the apparatus required is large, and expensive equipment must be introduced. In contrast, die molding can be performed using comparatively small and inexpensive equipment, and in particular is suited to the manufacture of small substrates such as those used in magnetic recording disks.

Smoothness is required of a glass substrate for use in a magnetic recording disk. When glass not containing alkali oxides is used in die molding, the molding must be performed at higher temperatures, and glass substrates having satisfactory smoothness are not easily obtained. In order to manufacture glass substrates for magnetic recording disks using die molding, it is preferable that the glass comprise alkali oxides. By this means, molding can be performed at comparatively low temperatures, and glass substrates with satisfactory smoothness can be obtained.

Moreover, in Japanese Patent Laid-open No. 2001-19466, a glass substrate is described which uses glass the water resistance of which, as measured by JIS-R3502, is 0.2 mg or less expressed as an alkaline elution amount, and the edge faces of which have been etched.

Means for preventing alkaline elution from glass substrates for magnetic recording disks have been proposed (see for example Japanese Patent Laid-open No. 2002-150549, Japanese Patent Laid-open No. 2002-220259, Japanese Patent Laid-open No. 2002-220260, Japanese Patent Laid-open No. 2002-362944, and Japanese Patent Laid-open No. 2005-187239). In Japanese Patent Laid-open No. 2002-150549 warm water is used, in Japanese Patent Laid-open No. 2002-220259 an aqueous solution containing lithium chloride is used, in Japanese Patent Laid-open No. 2002-220260 and Japanese Patent Laid-open No. 2005-187239 a melt liquid containing lithium chloride is used, and in Japanese Patent Laid-open No. 2002-362944 a high-temperature aqueous solution containing a metal salt is used. By immersing the substrate in these various liquids, alkali ion elution is prevented.

However, in ion substitution for glass tempering, the glass and ions must be kept in contact for a long period of time at high temperatures. Moreover, the ions are normally used in the form of a molten salt, so that equipment used for chemical tempering of glass for magnetic recording media must be large, resulting in high costs and inability to improve throughput.

Further, when forming a compressive tempering layer at the surface in chemical tempering, if there is foreign matter at the surface of the glass to be tempered, or if there is foreign matter within the chemical tempering vat, this foreign matter acts as a mask to cause depressions to form in the surface after tempering, so that the glass substrate for magnetic recording media becomes defective. For this reason, a high degree of cleanliness is required of glass substrate for magnetic recording media prior to tempering, incurring cleaning costs.

Further, in order to obtain practical tempering of the glass substrate described in Japanese Patent Laid-open No. 9-12333, it has been necessary to cover the etched inner-edge face with a protective film having a pencil hardness value of 5H or higher, such as a silica layer obtained by hardening a covering composition comprising polysilazane (see for example Japanese Patent Laid-open No. 11-328665).

Further, when using glass comprising an alkali oxide, if the glass substrate is manufactured without performing chemical tempering and used in a magnetic recording disk or other information recording media, then after use over a long period or in a high-temperature, high-humidity environment, alkali ions in the glass are eluted and migrate to the glass substrate surface, and then to the recording surface of the information recording medium. As a result, problems may occur, such as the appearance of deposits, film separation or damage to the recording layer, and, in the case of a magnetic recording disk, due to the very close proximity of the head which reads and writes magnetic information to the disk, damage to the head due to deposits.

When chemical tempering is performed, alkali ions in the glass such as lithium and sodium ions are replaced with potassium ions. Because potassium ions have a larger ionic radius than do lithium or sodium ions, there is less elution of alkali ions overall. However, elution of potassium ions does occur, and further measures are required.

In order to prevent problems arising from alkali ion elution without performing chemical tempering, there are methods in which glass not effectively containing alkali oxides is used, as disclosed in Japanese Patent Laid-open No. 9-12333, and there are methods in which glass with small alkaline elution amounts is used, as disclosed in Japanese Patent Laid-open No. 2001-19466. However, when using such methods, practical strength is not obtained merely by etching the inner-edge face, and means for further strengthening, using a protective layer or by adding lanthanide oxides, or by some other method, are required.

Further, although the methods disclosed in Japanese Patent Laid-open No. 2002-150549, Japanese Patent Laid-open No. 2002-220259, Japanese Patent Laid-open No. 2002-220260, Japanese Patent Laid-open No. 2002-362944, and Japanese Patent Laid-open No. 2005-187239 are effective in preventing alkaline elution, they do not improve the strength of the glass substrate.

In view of the above, it would be preferable to provide a method of manufacture of a glass substrate for a magnetic recording medium, which affords both high substrate strength and low alkaline elution amounts.

### SUMMARY OF THE INVENTION

A method of manufacture of a glass substrate for an information recording medium having an aluminosilicate composition of this invention is characterized by having an etching process of etching the inner-edge face of a donut-shaped glass substrate formed by removing the center portion of a die-molded disc-shaped glass substrate, and an alkali sealing process of performing alkali sealing treatment by proton substitution of alkali ions in the surface layer of the etched donut-shaped glass substrate.

Further, a method of manufacture of a magnetic recording disk of this invention is characterized in that at least a magnetic layer is formed on a glass substrate for an information recording medium manufactured by the above-described method.

Further, a magnetic recording disk of this invention is characterized by being manufactured by the above-described method of manufacture of a magnetic recording disk.

According to a method of manufacture of a glass substrate for an information recording medium of this invention, a glass substrate is etched using acid or using an alkaline solution, to remove scratches and cracks existing in the unpolished inner diameter, so that substrate cracking can be suppressed. An alkali sealing treatment performed after polishing enables formation of an alkali-poor layer at the surface, so that the amount of alkaline elution from the substrate after treatment can be reduced. This alkali sealing treatment cannot be effectively performed at temperatures lower than 110° C. Hence, the alkali sealing treatment is performed at temperatures of 110° C. and above. Further, if the alkali sealing treatment is performed at a temperature of 120 to 200° C., the equipment can be smaller compared with chemical tempering using high-temperature molten salts as in the prior art. The treatment time can also be reduced to 0.5 to 2 hours, and improvements can easily be made with respect to cost and to throughput. Further, in alkali sealing treatment there is no substitution of large-radius potassium ions for ions at the glass surface, as in chemical tempering, so that there is no occurrence of depression defects arising from adhesion of foreign matter to the glass substrate surface. Cleaning prior to alkali sealing treatment is also easy.

By combining an etching process with an alkali sealing process using proton exchange, as in this invention, it has become possible to achieve what could not previously be accomplished individually, which is improvement of the substrate strength and a high degree of alkali sealing. Specifically, a glass substrate is obtained that has a has a total alkaline elution amount of less than 3.1 μg/disk and magnetic recording medium that incorporates the glass substrate is obtained that has a transverse rupture strength greater than 132 N.

### BRIEF DESCRIPTION OF THE DRAWINGS

The invention will be described with reference to certain preferred embodiments thereof and the accompanying drawings, wherein:

FIG. 1 is a cross-sectional view of a magnetic recording medium in accordance with the claimed invention; and

FIG. 2 illustrates an apparatus for measuring a transverse rupture strength of a substrate.

### DESCRIPTION OF THE PREFERRED EMBODIMENTS

A method of manufacture of a glass substrate for an information recording medium having an aluminosilicate composition is described in claim 1 of the invention. The method comprises an etching process of etching the inner-edge face of a donut-shaped glass substrate formed by removing the center portion of a die-molded disc-shaped glass substrate, and an alkali sealing process of performing alkali sealing treatment by proton substitution of alkali ions in the surface layer of the etched donut-shaped glass substrate.

The etching process is explained below. In this etching process, at least the inner-edge face of a donut-shaped glass substrate is etched, and cracks in the inner edge are removed. Typical glass etching methods, including are wet etching methods using an etching liquid, dry etching methods using an etching gas, and similar methods can be used. Of these, etching using a hydrofluoric acid solution, ammonium fluoride, or a mixed liquid combining two or more of these, as well as a wet etching method employing an etching liquid comprising sodium hydroxide or another alkaline aqueous solution, can be used. A method using a hydrofluoric acid solution is particularly suitable.

This etching is generally performed by immersing the donut-shaped glass substrate into the etching liquid. However, a spray method or another treatment method can be used. This etching must be performed on the inner-edge face of the donut-shaped glass substrate, but it is preferable that the etching be performed on both the inner-edge face and on the outer-edge face. If excessive etching is performed, tall protrusions may be formed in the glass substrate surface, so it is preferable that etching be performed within a range which does not result in excessive etching.

Prior to etching, it is preferable that the inner-edge and outer-edge faces of the donut-shaped glass substrate, and in particular the inner-edge face, be finished using abrasive particles of size approximately #200 to #1000. It is also preferable that chamfering of the inner-edge and outer-edge faces of the donut-shaped glass substrate be performed, as necessary. It is also preferable that the inner-edge and outer-edge faces, and the chamfered inner-edge and outer-edge faces, be mirror-finished, using cerium oxide or another polishing material.

Through etching, deep scratches existing in the inner-edge and outer-edge faces which govern the bending strength of the donut-shaped glass substrate, and in particular deep scratches in the inner-edge face which strongly govern the bending strength, can be removed.

The etching amount of the glass substrate surfaces in the etching process, that is, the thickness of material removed from the glass surface by etching, is preferably from 1 to 50 μm. A thickness of less than 1 μm is insufficient to remove deep scratches existing in the inner-edge face in particular, and mechanical strength may be reduced. If 50 μm is exceeded, tall protrusions may be formed in the glass substrate surface.

After etching, and prior to the alkali treatment described below, it is preferable that the etched glass surface be polished. Cerium oxide and colloidal silica can be used in polishing.

Next, the alkali sealing treatment is explained. Alkali sealing treatment is a process performed to suppress elution of glass components. When the glass surface is brought into contact with the protons H⁺ in an aqueous solution containing a lithium salt, a carboxylic acid solution, or an aromatic carboxylic acid solution, ion exchange occurs between the Na⁺ and K⁺ ions in the glass surface and the protons H⁺ in the aqueous solution, the ionic diameter of which is small compared with the diameters of Na⁺ and K⁺. After the ion exchange, the protons H⁺ are strongly bonded with unbridged oxygen in the glass, and elution of glass components can be effectively suppressed.

This alkali sealing treatment can be performed by immersion of the substrate, comprising a glass material, in a solution comprising protons at 110° C. or higher, and preferably between 120° C. to 200° C. When the substrate is immersed in a lithium nitrate aqueous solution, or in one or more types of organic acids belonging to the carboxylic acids or aromatic carboxylic acids, then efficient treatment for elution suppression is possible at high temperature because the lithium nitrate or carboxylic acid is highly soluble in water, and because the boiling point of the aqueous solution also rises. If the treatment temperature is under 120° C., then the alkali sealing effect is inadequate. If the temperature exceeds 200° C., cracks appear in the glass substrate surface, and the strength is degraded.

Further, if the substrate is immersed in a lithium nitrate aqueous solution, or in a straight-chain carboxylic acid or aromatic carboxylic acid for 30 minutes or more, this is sufficient time to remove excess alkali from the glass substrate surface, and good throughput in terms of treatment time can be obtained. It is preferable that this immersion time be 120 minutes or less. There is no further improvement in the alkali sealing effect even upon immersion for longer than 120 minutes, and throughput is reduced, which is undesirable.

It is preferable that the aluminosilicate composition of the donut-shaped glass substrates used in a method of manufacture of a glass substrate for an information recording medium of this invention comprise 60 to 75 weight percent SiO₂, 5 to 15 weight percent Al₂O₃, 4 to 10 weight percent Li₂O, 4 to 10 weight percent Na₂O, 0 to 10 weight percent K₂O, and 5 to 15 weight percent ZrO₂, and that Li₂O+Na₂O+K₂O be 10 to 30 weight percent. When SiO₂ is 60 to 75 weight percent, Al₂O₃ is 5 to 15 weight percent, Li₂O is 4 to 10 weight percent, Na₂O is 4 to 10 weight percent, K₂O is 5 to 15 weight percent, and ZrO₂ is 5 to 15 weight percent, then a low melting point is possible. In order for the melting point to be low, it is necessary that Li₂O+Na₂O+K₂O be 10 weight percent or higher, but if greater than 30 weight percent, alkali elution is increased and the advantageous result of the alkali sealing treatment is not obtained.

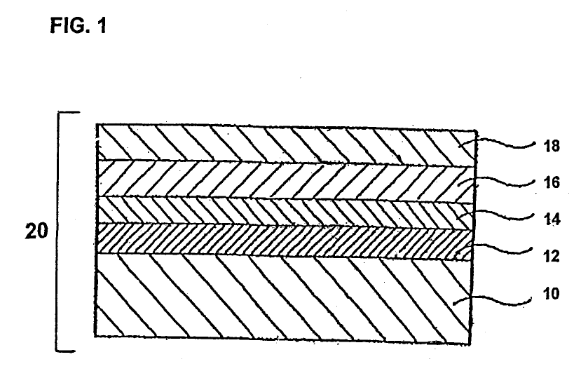

As shown in FIG. 1, a magnetic recording medium is obtained by forming an underlayer 12 on the glass substrate 10 and then forming a magnetic recording layer 14 on the underlayer 12. Any magnetic material normally used in conventional magnetic recording disk manufacture can be employed as the magnetic recording layer 14. A protective layer 16 and a lubricant layer 18 may be provided as necessary over the magnetic recording layer 14. The materials used in forming these layers, and any other desired layers, may likewise be the materials normally used in conventional manufacturing processes.

A magnetic recording medium 20 obtained in this way has superior performance, including high strength, minimal alkaline elution, and little disk film separation, recording layer damage, or damage to a head which reads and writes magnetic information.

### Embodiments

The invention is further explained below using embodiments.

(Evaluation of Transverse Rupture Strength)

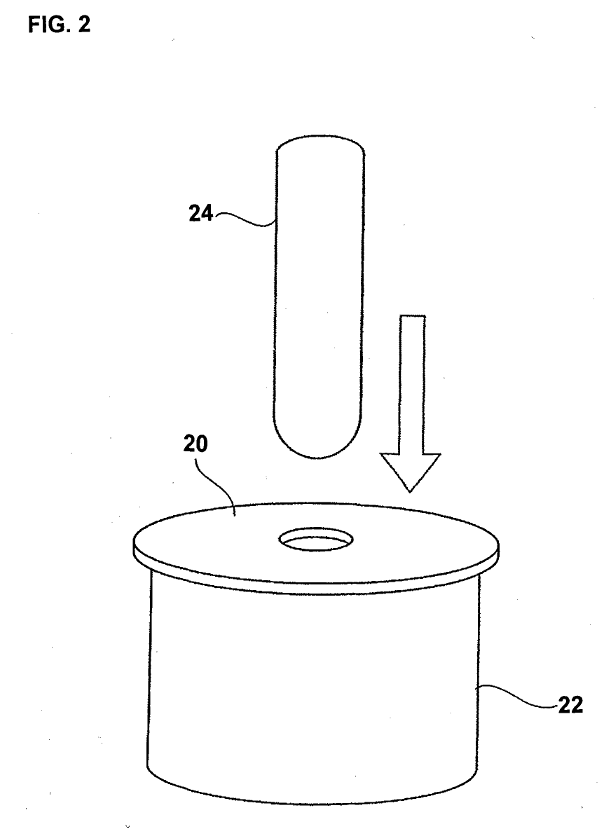

In the embodiments described below, the transverse rupture strength of 100 substrates was measured and evaluated using the following procedure, in order to evaluate the improvement in substrate strength. The transverse rupture strength was measured using a “Servo Pulser” system manufactured by Shimadzu Corp. FIG. 2 shows in summary the method of transverse rupture strength measurement. In order to measure the transverse rupture strength of a disc, the magnetic recording medium 20 is placed on an outer-perimeter holding jig 22, and a head 24, the tip of which is spherical, is pressed down from above, and pressure is applied to the inner diameter. The stress at the time the magnetic recording medium 20 cracked was taken to be the transverse rupture strength.

(Evaluation of Alkaline Elution Amount)

In the embodiments below, alkaline elution amounts from the substrate were analyzed using the following procedure, in order to evaluate the effect of alkaline elution prevention of crystalline thin films.

(1) 10 ml of distilled water was placed in a Teflon (a registered trademark) container with a lid, with volume 0.5 L, and one substrate for evaluation was placed in the container.

(2) The container was placed in a thermostatic chamber at 80° C. and left for 24 hours.

(3) The Teflon container was removed from the thermostatic chamber, and ICP analysis was performed to investigate alkaline elements eluted into the distilled water. The amount of Li+Na+K was evaluated as the total alkaline elution amount.

### Embodiment 1

Donut-shaped glass disc plates (chamfered, lapped and polished), of outer diameter 65 mm, inner diameter 20 mm, and thickness approximately 0.64 mm, of glass comprising 60 weight percent SiO₂, 15 weight percent Al₂O₃, 7 weight percent Li₂O, 8 weight percent Na₂O, and 10 weight percent ZrO₂, were prepared. The glass plates were immersed for 5 minutes in a hydrofluoric acid aqueous solution containing 5 weight percent hydrofluoric acid, to perform etching to a depth of approximately 10 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of these glass plates, the plates were placed in an aqueous solution of 50 weight percent lithium nitrate, and heated to 120° C. for one hour.

(Film Deposition Process)

On glass plates subjected to the above treatment, sputtering was used to deposit a Cr underlayer, Co—Cr—Pt magnetic layer, and carbon (C) protective layer, in order; dip-coating was then used to apply a fluoride liquid lubricant, to obtain a magnetic recording disk. The transverse rupture strength and alkaline elution amounts of the magnetic recording disk thus obtained were evaluated. Results appear in Table 1.

### Embodiment 2

Donut-shaped glass disc plates (chamfered, lapped and polished), of outer diameter 65 mm, inner diameter 20 mm, and thickness approximately 0.64 mm, of glass comprising 65 weight percent SiO₂, 5 weight percent Al₂O₃, 10 weight percent Li₂O, 5 weight percent Na₂O, 5 weight percent K₂O, and 10 weight percent ZrO₂, were prepared. The glass plates were immersed for 15 minutes in an ammonium fluoride aqueous solution containing 40 weight percent ammonium fluoride, to perform etching to a depth of approximately 5 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of these glass plates, the plates were placed in an aqueous solution of 65 weight percent lithium sulfate, and heated to 150° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 1 together with those for Embodiment 1.

### Embodiment 3

Donut-shaped glass disc plates (chamfered, lapped and polished), of outer diameter 65 mm, inner diameter 20 mm, and thickness approximately 0.64 mm, of glass comprising 65 weight percent SiO₂, 10 weight percent Al₂O₃, 7 weight percent Li₂O, 8 weight percent Na₂O, and 10 weight percent ZrO₂, were prepared. The glass plates were immersed for 120 minutes in a sodium hydroxide aqueous solution containing 10 weight percent sodium hydroxide, to perform etching to a depth of approximately 1 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of these glass plates, the plates were placed in an aqueous solution of 80 weight percent lithium nitrate, and heated to 180° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 1 together with those for Embodiment 1.

### Embodiment 4

Donut-shaped glass disc plates (chamfered, lapped and polished), of outer diameter 65 mm, inner diameter 20 mm, and thickness approximately 0.64 mm, of glass comprising 68 weight percent SiO₂, 8 weight percent Al₂O₃, 4 weight percent Li₂O, 4 weight percent Na₂O, 10 weight percent K₂O, and 6 weight percent ZrO₂, were prepared. The glass plates were immersed for 5 minutes in a hydrofluoric acid aqueous solution containing 5 weight percent hydrofluoric acid, to perform etching to a depth of approximately 10 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of these glass plates, the plates were placed in an aqueous solution of adipic acid (HOOC(CH₂)₄COOH), and heated to 130° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 1 together with those for Embodiment 1.

### Embodiment 5

Donut-shaped glass disc plates (chamfered, lapped and polished), of outer diameter 65 mm, inner diameter 20 mm, and thickness approximately 0.64 mm, of glass comprising 70 weight percent SiO₂, 8 weight percent Al₂O₃, 6 weight percent Li₂O, 10 weight percent Na₂O, and 6 weight percent ZrO₂, were prepared. The glass plates were immersed for 5 minutes in a hydrofluoric acid aqueous solution containing 5 weight percent hydrofluoric acid, to perform etching to a depth of approximately 10 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of these glass plates, the plates were placed in an aqueous solution of decanoic acid (CH₃(CH₂)₈COOH), and heated to 150° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 1 together with those for Embodiment 1.

### Embodiment 6

Donut-shaped glass disc plates (chamfered, lapped and polished), of outer diameter 65 mm, inner diameter 20 mm, and thickness approximately 0.64 mm, of glass comprising 75 weight percent SiO₂, 5 weight percent Al₂O₃, 5 weight percent Li₂O, 5 weight percent Na₂O, and 10 weight percent ZrO₂, were prepared. The glass plates were immersed for 10 minutes in a hydrofluoric acid aqueous solution containing 1 weight percent hydrofluoric acid, to perform etching to a depth of approximately 5 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of these glass plates, the plates were placed in an aqueous solution of salicylic acid (HO—C₆H₄—COOH), and heated to 160° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 1 together with those for Embodiment 1.

### Comparison Example 1

Donut-shaped glass disc plates (chamfered, lapped and polished), of outer diameter 65 mm, inner diameter 20 mm, and thickness approximately 0.64 mm, of glass comprising 60 weight percent SiO₂, 15 weight percent Al₂O₃, 7 weight percent Li₂O, 8 weight percent Na₂O, and 10 weight percent ZrO₂, were prepared. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. Film deposition processes similar to those of Embodiment 1 were performed, to obtain a magnetic recording medium. Transverse rupture strengths and alkaline elution amounts were evaluated similarly to Embodiment 1. The results are shown in Table 2.

### Comparison Example 2

Donut-shaped glass disc plates (chamfered, lapped and polished), of outer diameter 65 mm, inner diameter 20 mm, and thickness approximately 0.64 mm, of glass comprising 65 weight percent SiO₂, 5 weight percent Al₂O₃, 10 weight percent Li₂O, 5 weight percent Na₂O, 5 weight percent K₂O, and 10 weight percent ZrO₂, were prepared. The glass plates were immersed for 0.5 minute in a hydrofluoric acid aqueous solution containing 5 weight percent hydrofluoric acid, to perform etching to a depth of approximately 0.5 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. Film deposition processes similar to those of Embodiment 1 were performed, to obtain a magnetic recording medium. Transverse rupture strengths and alkaline elution amounts were evaluated similarly to Embodiment 1. The results are shown in Table 2.

### Comparison Example 3

Donut-shaped glass disc plates (chamfered, lapped and polished), of outer diameter 65 mm, inner diameter 20 mm, and thickness approximately 0.64 mm, of glass comprising 65 weight percent SiO₂, 10 weight percent Al₂O₃, 7 weight percent Li₂O, 8 weight percent Na₂O, and 10 weight percent ZrO₂, were prepared. The glass plates were immersed for 60 minutes in a sodium hydroxide aqueous solution containing 10 weight percent sodium hydroxide, to perform etching to a depth of approximately 0.5 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. Film deposition processes similar to those of Embodiment 1 were performed, to obtain a magnetic recording medium. Transverse rupture strengths and alkaline elution amounts were evaluated similarly to Embodiment 1. The results are shown in Table 2.

### Comparison Example 4

Donut-shaped glass disc plates (chamfered, lapped and polished), of outer diameter 65 mm, inner diameter 20 mm, and thickness approximately 0.64 mm, of glass comprising 68 weight percent SiO₂, 8 weight percent Al₂O₃, 4 weight percent Li₂O, 4 weight percent Na₂O, 10 weight percent K₂O, and 6 weight percent ZrO₂, were prepared. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of the glass substrates, the substrates were placed in an aqueous solution of adipic acid (HOOC(CH₂)₄COOH), and heated to 100° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 2.

### Comparison Example 5

Donut-shaped glass disc plates (chamfered, lapped and polished), of outer diameter 65 mm, inner diameter 20 mm, and thickness approximately 0.64 mm, of glass comprising 70 weight percent SiO₂, 8 weight percent Al₂O₃, 6 weight percent Li₂O, 10 weight percent Na₂O, and 6 weight percent ZrO₂, were prepared. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of the glass substrates, the substrates were placed in an aqueous solution of decanoic acid (CH₃(CH₂)₈COOH), and heated to 100° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 2.

### Comparison Example 6

Donut-shaped glass disc plates (chamfered, lapped and polished), of outer diameter 65 mm, inner diameter 20 mm, and thickness approximately 0.64 mm, of glass comprising 75 weight percent SiO₂, 5 weight percent Al₂O₃, 5 weight percent Li₂O, 5 weight percent Na₂O, and 10 weight percent ZrO₂, were prepared. The glass plates were immersed for 0.5 minute in a hydrofluoric acid aqueous solution containing 5 weight percent hydrofluoric acid, to perform etching to a depth of approximately 0.5 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of the glass substrates, the substrates were placed in an aqueous solution of salicylic acid (HO—C₆H₄—COOH), and heated to 100° C. for one hour. Transverse rupture strengths and alkaline elution amounts were evaluated similarly to Embodiment 1. The results are shown in Table 2.

### Comparison Example 7

Donut-shaped glass disc plates (chamfered, lapped and polished), of outer diameter 65 mm, inner diameter 20 mm, and thickness approximately 0.64 mm, of glass comprising 60 weight percent SiO₂, 15 weight percent Al₂O₃, 7 weight percent Li₂O, 8 weight percent Na₂O, and 10 weight percent ZrO₂, were prepared. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. After precision cleaning of the glass substrates, the substrates were placed in an aqueous solution of 50 weight percent lithium sulfate, and heated to 120° C. for one hour. Film deposition processes similar to those of Embodiment 1 were performed, to obtain a magnetic recording medium. Transverse rupture strengths and alkaline elution amounts were evaluated similarly to Embodiment 1. The results are shown in Table 2.

### Comparison Example 8

Donut-shaped glass disc plates (chamfered, lapped and polished), of outer diameter 65 mm, inner diameter 20 mm, and thickness approximately 0.64 mm, of glass comprising 60 weight percent SiO₂, 15 weight percent Al₂O₃, 7 weight percent Li₂O, 8 weight percent Na₂O, and 10 weight percent ZrO₂, were prepared. The glass plates were immersed for 5 minutes in a hydrofluoric acid aqueous solution containing 5 weight percent hydrofluoric acid, to perform etching to a depth of approximately 10 μm. Then, coarse polishing of approximately 20 μm of the glass plates was performed using cerium oxide abrasive with an average particle diameter of 2.5 μm. Colloidal silica with an average particle diameter of 0.1 μm was used in finishing of approximately 1 μm. Transverse rupture strengths and alkaline elution amounts were evaluated similarly to Embodiment 1. The results are shown in Table 2.

TABLE 1

| Embodiment | 1 | 2 | 3 | 4 | 5 | 6 |
|---|---|---|---|---|---|---|
| SiO₂ (wt %) | 60 | 65 | 65 | 68 | 70 | 75 |
| Al₂O₃ (wt %) | 15 | 5 | 10 | 8 | 8 | 5 |
| Li₂O (wt %) | 7 | 10 | 7 | 4 | 6 | 5 |
| Na₂O (wt %) | 8 | 5 | 8 | 4 | 10 | 5 |
| K₂O (wt %) | 0 | 5 | 0 | 10 | 0 | 0 |
| ZrO₂ (wt %) | 10 | 10 | 10 | 6 | 6 | 10 |
| Etching amount (μm) | 10 | 5 | 1 | 10 | 10 | 5 |
| Alkali sealing | 120 | 150 | 180 | 130 | 150 | 160 |
| treatment(° C.) | | | | | | |
| Total alkaline elution | 2.7 | 3.0 | 2.9 | 3.1 | 3.0 | 2.7 |
| amount (μg/disk) | | | | | | |
| Transverse rupture | 162 | 154 | 132 | 158 | 163 | 149 |
| strength (N) | | | | | | |

TABLE 2

| Comparison Example | 1 | 2 | 3 | 4 | 5 | 6 | 7 | 8 |
|---|---|---|---|---|---|---|---|---|
| SiO₂ (wt %) | 60 | 65 | 65 | 68 | 70 | 75 | 60 | 60 |
| Al₂O₃ (wt %) | 15 | 5 | 10 | 8 | 8 | 5 | 15 | 15 |
| Li₂O (wt %) | 7 | 10 | 7 | 4 | 6 | 5 | 7 | 7 |
| Na₂O (wt %) | 8 | 5 | 8 | 4 | 10 | 5 | 8 | 8 |
| K₂O (wt %) | 0 | 5 | 0 | 10 | 0 | 0 | 0 | 0 |
| ZrO₂ (wt %) | 10 | 10 | 10 | 6 | 6 | 10 | 10 | 10 |
| Etching amount (μm) | — | 0.5 | 0.5 | — | — | 0.5 | — | 10 |
| Alkali sealing | — | — | — | 100 | 100 | 100 | 120 | — |
| treatment(° C.) | | | | | | | | |
| Total alkaline elution | 29.0 | 30.5 | 29.3 | 20.3 | 19.4 | 17.8 | 2.7 | 31.3 |
| amount (μg/disk) | | | | | | | | |
| Transverse rupture | 68 | 82 | 84 | 78 | 63 | 82 | 69 | 163 |
| strength (N) | | | | | | | | |

In Embodiments 1 through 6, the transverse rupture strength was improved through etching with hydrofluoric acid, and the alkaline elution amount was suppressed through alkali sealing treatment with lithium nitrate. In contrast, the transverse rupture strength was low, and there was much alkaline elution, for Comparison Example 1, in which neither etching nor alkali sealing treatment were performed. In Comparison Examples 2 and 3, etching was performed, but there was no alkali sealing treatment, so that alkaline elution was considerable, and strength was also low. In Comparison Examples 4 and 5, alkali sealing treatment was performed, but there was no etching, and the transverse rupture strength was low. In Comparison Example 6, because of the low etching and alkali sealing temperatures, the alkaline elution amount was considerable, and strength was insufficient. In Comparison Example 7, the composition was similar to that of Embodiment 1, but etching was not performed, so that strength was inadequate. In Comparison Example 8, the composition was similar to that of Embodiment 1, but alkali sealing treatment was not performed, so that the elution amount was large, and results were unsatisfactory.

As explained above, by means of a method of manufacture of a glass substrate for an information recording medium of this invention, glass substrates for magnetic recording media can be provided which have high strength and reduced amounts of alkaline elution. Because magnetic disks which employ glass substrates obtained by a manufacturing method of this invention have high strength and small alkaline elution amounts, they are highly suitable for use in hard disk devices, or in other applications as information recording media.

The invention has been described with respect to certain preferred embodiments thereof. It will be understood that modifications and variations are possible within the scope of the appended claims.

What is claimed is:

1. A method of manufacture comprising:
etching an inner-edge face of a die-molded and donut-shaped glass substrate including an aluminosilicate composition; and
performing an alkali sealing treatment by proton substitution of alkali ions in a surface layer of the etched donut-shaped glass substrate.

2. The method of manufacture according to claim 1, wherein the step of performing alkali sealing treatment is an alkali removal step in which excess alkali in the glass substrate surface is removed.

3. The method of manufacture according to claim 2, wherein the alkali sealing treatment is a high-temperature immersion step in which the glass substrate is immersed in a solution comprising protons at 120° C. to 200° C.

4. The method of manufacture according to claim 3, wherein the alkali sealing treatment is a high-temperature immersion step in which the glass substrate is immersed in a heated solution comprising a lithium salt.

5. The method of manufacture according to claim 2, wherein the alkali sealing treatment is a high-temperature immersion step in which the glass substrate is immersed in a heated solution comprising one or more types of organic acids belonging to straight-chain carboxylic acids or aromatic carboxylic acids.

6. The method of manufacture according to claim 3, wherein the alkali sealing treatment is a high-temperature immersion step in which the glass substrate is immersed in a heated solution comprising one or more types of organic acids belonging to straight-chain carboxylic acids or aromatic carboxylic acids.

7. The method of manufacture according to claim 3, wherein the high-temperature immersion step has a duration of 30 minutes or more.

8. The method of manufacture according to claim 5, wherein the high-temperature immersion step has a duration of 30 minutes or more.

9. The method of manufacture according to claim 1, wherein the aluminosilicate composition comprises 60 to 75 weight percent SiO₂, 5 to 15 weight percent Al₂O₃, 4 to 10 weight percent Li₂O, 4 to 10 weight percent Na₂O, 0 to 10 weight percent K₂, and 5 to 15 weight percent ZrO₂, and is such that Li₂O+Na₂O+K₂O is 10 to 30 weight percent.

10. The method of manufacture according to claim 1, wherein the etching of the inner-edge face is treatment using a solution comprising hydrofluoric acid, ammonium fluoride aqueous solution, or a liquid mixture of two or more types containing these.

11. The method of manufacture according to claim 1, wherein the etching of the inner-edge face is treatment using an alkaline aqueous solution.

12. The method of manufacture according to claim 1, further comprising a step of polishing the surface of the glass substrate after the etching treatment and before the alkali sealing treatment.

13. A method of manufacture as claimed in claim 1, further comprising forming a magnetic layer is over the glass substrate.

14. A method of manufacture as claimed in claim 13, further comprising forming an underlayer on the glass substrate before forming the magnetic layer, forming the magnetic layer on the underlayer, forming a protective layer on the magnetic layer and forming a lubricant layer on the protective layer.

15. A magnetic recording medium, comprising:
a die-molded and alkali sealed glass substrate including an aluminosilicate composition; and
a magnetic recording layer formed over the glass substrate.

16. A magnetic recording medium as claimed in claim 15, wherein the glass substrate has a total alkaline elution amount of less than 3.1 μg/disk, and wherein the magnetic recording medium has a transverse rupture strength greater than 132 N.

17. A magnetic recording medium as claimed in claim 15, further comprising an underlayer formed on the glass substrate, and wherein the magnetic recording layer is formed on the underlayer.

18. A magnetic recording medium as claimed in claim 17, further comprising a protection layer formed on the magnetic recording layer and a lubrication layer formed on the protection layer.

19. A magnetic recording medium manufactured by a process comprising:
etching an inner-edge face of a die-molded glass substrate including an aluminosilicate composition;
performing an alkali sealing treatment by proton substitution of alkali ions in a surface layer of the die-molded glass substrate; and
forming a magnetic recording layer over the die-molded glass substrate.

20. A magnetic recording medium as claimed in claim 19, wherein the glass substrate has a total alkaline elution amount of less than 3.1 μg/disk, and wherein the magnetic recording medium has a transverse rupture strength greater than 132 N.
